(19) United States
(12) Patent Application Publication
(10) Pub. No.: US 2026/0349230 A1
(43) Pub. Date: Nov. 5, 2026

(54) OPTICAL CAVITY ELEMENT FOR GENERATING INCOHERENT ILLUMINATION FROM LASER SOURCE

(71) Applicant: KLA Corporation, Milpitas, CA (US)

(72) Inventors: Guoheng Zhao, Palo Alto, CA (US); Yihua Hao, San Jose, CA (US); Bin Wu, Milpitas, CA (US)

(21) Appl. No.: 19/532,363

(22) Filed: Feb. 6, 2026

Related U.S. Application Data
(60) Provisional application No. 63/798,563, filed on May 2, 2025.

(51) Int. Cl. G02B 17/00; G01N 21/88; G01N 21/95

(52) U.S. Cl. CPC G02B 17/004; G01N 21/8806; G01N 21/9501; G01N 2201/06113

(57) ABSTRACT

An optical system for reducing the coherence of a laser beam may include an optical cavity element formed from an optically transparent material having polished surfaces. The optical cavity element may include an input port configured to inject the laser beam into the optical cavity element. The optical cavity element may include an output port configured to extract incoherent light from the optical cavity element. The laser beam may circulate within the optical cavity element based on multiple total internal reflections from at least some of the polished surfaces. Different portions of the laser beam may travel different optical path lengths within the optical cavity element. At least one of a temporal coherence or a spatial coherence may be smaller for the incoherent light than for the laser beam.

### CROSS-REFERENCE TO RELATED APPLICATIONS

The present application claims the benefit under 35 U.S.C. § 119(e) of U.S. Provisional Application No. 63/798,563 filed on May 2, 2025, which is incorporated herein by reference in the entirety.

### TECHNICAL FIELD

The present disclosure relates generally to optical illumination systems and, more particularly, to generating incoherent illumination from input coherent laser light using circulation through an optical cavity element providing different optical path lengths to different portions of the input laser light.

### BACKGROUND

Sample characterization systems, including inspection tools and metrology tools, utilize high power light sources for illumination to meet sensitivity and throughput requirements. However, not all output power from a light source can be utilized effectively. The amount of usable light that actually reaches a detector depends on the type of light source and the design of the illumination system. The optical invariants of the light source and the imaging system impose fundamental limits on light utilization. High power incoherent light sources such as lamps or LEDs generally have large optical invariants because light emits in all directions over a broad spectrum and the light emitting area is large. Consequently, the usable light from such incoherent light sources is typically a small fraction of the total output power.

One approach to creating high brightness incoherent light is to reduce the coherent of laser light. Lasers are diffraction limited with small optical invariants, enabling substantially all output power to be used for illumination. Various speckle busting approaches have been developed, including rotating diffusers, vibrated multi-mode fibers, and fiber bundles with different lengths, but each has significant limitations. For example, rotating diffusers are too slow for high-speed wafer inspection with integration times around tens of microseconds, fiber bundle approaches require large numbers of fibers that increase effective source size and optical invariants, and fibers have low transmission and low laser damage thresholds at deep ultraviolet wavelengths. Therefore, it is desirable to provide systems and methods for curing the above deficiencies.

### SUMMARY

In embodiments, an optical system is provided. The optical system may include an optical cavity element formed from an optically transparent material having polished surfaces. The optical cavity element may include an input port configured to inject a laser beam into the optical cavity element and an output port configured to extract incoherent light from the optical cavity element. The laser beam may circulate within the optical cavity element based on multiple total internal reflections from at least some of the polished surfaces. Different portions of the laser beam may travel different optical path lengths within the optical cavity element. At least one of a temporal coherence or a spatial coherence may be smaller for the incoherent light than for the laser beam.

In embodiments, the optical path length of a particular portion of the laser beam within the optical cavity element may be controllable based on at least one of an incidence angle or an incident location on the input port.

In embodiments, at least one of a size or a shape of the optical cavity element may be configured to provide that a spread of the optical path lengths is greater than a selected coherence length.

In embodiments, at least one of the input port or the output port may be formed from a prism in contact with at least one of the polished surfaces.

In embodiments, at least one of the input port or the output port may be formed from a notch in one of the polished surfaces.

In embodiments, the optical cavity element may include a disk having a circular cross-section with two flat surfaces and a curved peripheral surface.

In embodiments, the optical cavity element may include a ring having an inner curved surface and an outer curved surface.

In embodiments, a width of the ring between the inner curved surface and the outer curved surface may be configured to control a cross-sectional size of the incoherent light.

In embodiments, at least one of the input port or the output port may be located on at least one of the two flat surfaces, the inner curved surface, or the outer curved surface.

In embodiments, the optical system may further include a light pipe optically coupled to the output port. The light pipe may be configured to increase spatial homogeneity of the incoherent light.

In embodiments, the light pipe may have a rectangular cross-section configured to match a shape of a sensor.

In embodiments, the optical system may further include a diffuser prior to the input port to control an angular spread of the laser beam entering the input port.

In embodiments, the optically transparent material may include at least one of fused silica or calcium fluoride.

In embodiments, a sample characterization tool is provided. The sample characterization tool may include a laser source configured to generate a laser beam. The sample characterization tool may include an optical cavity element formed from an optically transparent material having polished surfaces. The optical cavity element may include an input port configured to receive the laser beam and an output port configured to extract incoherent light from the optical cavity element. The laser beam may circulate within the optical cavity element based on multiple total internal reflections from at least some of the polished surfaces. Different portions of the laser beam may travel different optical path lengths within the optical cavity element. At least one of a temporal coherence or a spatial coherence may be smaller for the incoherent light than for the laser beam. The sample characterization tool may include illumination optics configured to direct the incoherent light to a sample. The sample characterization tool may include a detector configured to detect light from the sample. The sample characterization tool may include a controller including one or more processors configured to execute program instructions causing the one or more processors to generate one or more measurements of the sample based on signals from the detector.

In embodiments, the sample characterization tool may include an inspection tool. The one or more measurements may include at least one of identifying or categorizing defects on the sample.

In embodiments, the sample characterization tool may include a metrology tool. The one or more measurements may include one or more measurements of a physical property of the sample.

In embodiments, the sample characterization tool may further include one or more imaging optics to image the sample onto the detector based on illumination by the incoherent light.

In embodiments, the laser source may include at least one of a mode-locked laser or a Q-switched laser.

In embodiments, the optical path length of a particular portion of the laser beam within the optical cavity element may be controllable based on at least one of an incidence angle or an incident location on the input port.

In embodiments, at least one of a size or a shape of the optical cavity element may be configured to provide that a spread of the optical path lengths is greater than a coherence length of the laser beam.

In embodiments, at least one of the input port or the output port may be formed from a prism in contact with at least one of the polished surfaces.

In embodiments, the optical cavity element may include a disk having a circular cross-section with two flat surfaces and a curved peripheral surface.

In embodiments, the optical cavity element may include a ring having an inner curved surface and an outer curved surface.

In embodiments, a method for generating incoherent illumination from a coherent laser source is provided. The method may include injecting a laser beam into an optical cavity element through an input port. The optical cavity element may be formed from an optically transparent material having polished surfaces. The method may include circulating the laser beam within the optical cavity element based on multiple total internal reflections from at least some of the polished surfaces. Different portions of the laser beam may travel different optical path lengths within the optical cavity element. The method may include extracting incoherent light from the optical cavity element through an output port. At least one of a temporal coherence or a spatial coherence may be smaller for the incoherent light than for the laser beam.

In embodiments, the optical path length of a particular portion of the laser beam within the optical cavity element may be based on at least one of an incidence angle or an incident location on the input port.

In embodiments, at least one of the input port or the output port may be formed from a prism in contact with at least one of the polished surfaces of the optical cavity element.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures in which:

FIG. 1 is a block diagram of an incoherent light source for generating incoherent illumination from a coherent laser source, in accordance with one or more embodiments of the present disclosure.

FIG. 2 is a top view of an optical cavity element configured as a disk with a circular cross-section, in accordance with one or more embodiments of the present disclosure.

FIG. 3 is a perspective view of the optical cavity element showing different optical path lengths within the optical cavity element due to different incidence angles of a laser beam, in accordance with one or more embodiments of the present disclosure.

FIG. 4 is a perspective view of an optical cavity element configured as a ring having an inner curved surface and an outer curved surface, in accordance with one or more embodiments of the present disclosure.

FIG. 5 is an interior perspective view of an optical cavity element depicting a notch providing an input port and an output port, in accordance with one or more embodiments of the present disclosure.

FIG. 6 is a plot of cumulated output efficiency as a function of number of cycles through an optical cavity element, in accordance with one or more embodiments of the present disclosure.

FIG. 7A is a perspective view of an optical cavity element with an integrated light pipe for generating spatially-uniform incoherent illumination, in accordance with one or more embodiments of the present disclosure.

FIG. 7B is a plot of irradiance of incoherent light at an output face of the light pipe, in accordance with one or more embodiments of the present disclosure.

FIG. 8 is a block diagram of a sample characterization system incorporating an optical cavity element for generating incoherent illumination from a coherent laser source, in accordance with one or more embodiments of the present disclosure.

FIG. 9 is a schematic diagram of a sample characterization system providing brightfield characterization of a sample, in accordance with one or more embodiments of the present disclosure.

FIG. 10 is a flowchart illustrating a method for generating incoherent illumination from a coherent laser source, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing incoherent illumination from coherent laser sources using optical cavity elements that circulate and delay portions of laser beams through total internal reflection. In embodiments, an optical cavity element formed from an optically transparent material with polished surfaces receives a laser beam through an input port and circulates the laser beam within the cavity based on multiple total internal reflections, where different portions of the laser beam travel different optical path lengths before exiting through an output port as incoherent light with reduced temporal or spatial coherence compared to the input laser beam.

It is contemplated herein that optical cavity elements may be used to transform coherent laser light into incoherent illumination suitable for, but not limited to, bright field systems by imparting different optical path lengths on different portions of incident laser light. In particular, when optical path length differences between different portions of the input light exceed the coherence length of the input light, the output light may be substantially incoherent.

As used herein, the term “incoherent light” refers to light having reduced temporal coherence, reduced spatial coherence, or both, relative to a reference light source. Temporal coherence relates to the correlation of the phase of a light wave at different points along the direction of propagation, and reduced temporal coherence may result when different portions of light travel different optical path lengths that exceed the coherence length of the source. Spatial coherence relates to the correlation of the phase of a light wave at different points perpendicular to the direction of propagation. Incoherent light may exhibit reduced speckle contrast when used for illumination compared to coherent light from the same source.

In embodiments, an optical cavity element such as a disk or ring formed from high-purity optical glass circulates laser light through total internal reflection from polished surfaces, where different portions of the laser beam undergo different numbers of circulations before exiting through an output port. The optical path length of a particular portion of the laser beam within the optical cavity element may be controlled based on at least one of an incidence angle or an incident location on the input port. Accordingly, an optical cavity element may be designed, potentially along with desired focusing characteristics of an input laser beam, to provide a spread of optical path length differences greater than the coherence length of a known laser source. As a result, the portions of the laser beam that exit after different numbers of circulations may recombine incoherently to provide an incoherent light output. For example, a mode-locked laser with a pulse width of 10-50 picoseconds may have a coherence length of 3-15 millimeters in air or 2-10 millimeters inside glass with a refractive index of 1.5, which may be achieved with a disk diameter of only a few millimeters.

The systems and methods disclosed herein may enable significant advantages over conventional speckle reduction methods by providing a static solution with no moving parts that can accommodate high-speed wafer inspection systems. For example, in some implementations, the optical cavity element may be formed from high-purity UV-grade materials such as fused silica or calcium fluoride that have much higher laser damage thresholds and higher transmission than optical fibers at deep ultraviolet wavelengths. As another example, a material with a relatively high refractive index such as, but not limited to, sapphire can also be used to increase the effective optical path length for a given physical size. The optical cavity element may be compact, with dimensions on the order of 10 millimeters in diameter and a few millimeters thick for mode-locked lasers, which is much easier to integrate with wafer inspection systems than fiber bundles.

In some embodiments, a light pipe or other homogenizer may be optically coupled to the output port of the optical cavity element to increase spatial homogeneity of the incoherent light. Further, an output face of the light pipe may be designed to correspond to a detector or other downstream optical component to further promote efficient light utilization.

In some embodiments, coherence reduction using an optical cavity element is coupled with additional coherence-reducing techniques such as, but not limited to, diffusers to control input beam angular spread or rotating diffusers to provide multiplicative speckle reduction when additional averaging is beneficial.

Some embodiments of the present disclosure are directed to an optical system for generating incoherent illumination from a coherent laser source, where an optical cavity element formed from an optically transparent material with polished surfaces receives a laser beam through an input port and circulates the beam through multiple total internal reflections such that different portions travel different optical path lengths before exiting through an output port as incoherent light. Some embodiments are directed to a sample characterization tool incorporating such an optical cavity element, where a laser source generates a laser beam that is converted to incoherent light by the optical cavity element, and the incoherent light is directed through illumination optics to a sample, with a detector capturing light from the sample and a controller generating measurements based on the detector signals. Some embodiments are directed to a method for generating incoherent illumination from a coherent laser source, including injecting a laser beam into an optical cavity element, circulating the laser beam within the optical cavity element through multiple total internal reflections where different portions travel different optical path lengths, and extracting incoherent light from the optical cavity element.

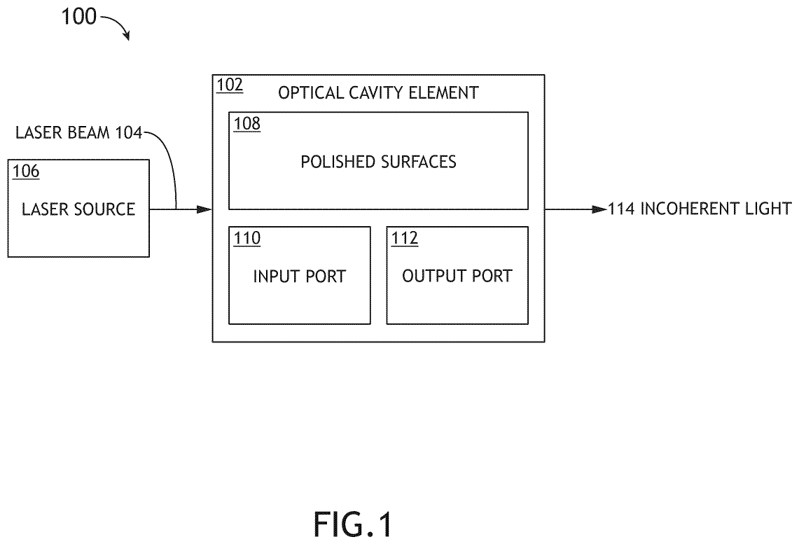

Referring now to FIGS. 1-10, systems and methods for generating incoherent light from coherent laser light are described in greater detail, in accordance with one or more embodiments of the present disclosure.

FIG. 1 is a block diagram of an incoherent light source 100 for generating incoherent illumination from a coherent laser source, in accordance with one or more embodiments of the present disclosure.

In embodiments, the incoherent light source 100 includes an optical cavity element 102 configured to accept a laser beam 104 from a laser source 106 and circulate different portions of the laser beam 104 with different optical path lengths to provide incoherent light 114. For example, the optical cavity element 102 may include an input port 110 configured to inject the laser beam 104 into the optical cavity element 102 and an output port 112 configured to extract incoherent light 114 from the optical cavity element 102. The laser beam 104 may circulate within the optical cavity element 102 based on multiple total internal reflections from various the polished surfaces 108, where different portions of the laser beam 104 may undergo different numbers of reflections and/or different numbers of trips through the optical cavity element 102. As a result, the temporal and/or spatial coherence of the resulting incoherent light 114 from the output port 112 is smaller than the temporal and/or spatial coherence of the input laser beam 104.

The optical cavity element 102 may have any shape including, but not limited to, a disk, a ring, a rectangular shape, or any polygon shape. The shape of the optical cavity element 102 may be selected based on desired optical path length distributions, coupling efficiency, manufacturability, or other design considerations.

The input port 110 and the output port 112 may have any design suitable for injecting light into and extracting light from the optical cavity element 102. The input port 110 and the output port 112 may be associated with a common structure or different separate structures. Further, the input port 110 and/or the output port 112 may be provided as separate components in optical contact with the optical cavity element 102 or may be monolithically integrated with the optical cavity element 102. In some embodiments, the input port 110 and the output port 112 are associated with one or more faces of a common optical element. For example, the input port 110 and/or the output port 112 may be formed from a prism in optical contact with or monolthically integrated into the optical cavity element 102. As another example, the input port 110 and/or the output port 112 may be formed from a notch machined into the optical cavity element 102.

It is contemplated herein that the optical path length of a particular portion of the laser beam 104 within the optical cavity element 102 is controllable, at least in part, based on the incidence angle and/or an incident location on the input port 110. In this way, a spread or distribution of optical path lengths associated with various portions of the laser beam as it circulates through the optical cavity element 102 may be controllable based on a numerical aperture (NA) and/or beam size of the laser beam 104 on the input port 110.

In some embodiments, at least one of a size or a shape of the optical cavity element 102 is configured to provide that a spread of the optical path lengths is greater than a selected coherence length. For example, the size and shape of the optical cavity element 102 may be designed such that the optical path length differences between different portions of the laser beam 104 exceed the coherence length of a laser beam 104 from a known laser source 106. In this way, the optical cavity element 102 may be designed to transform a known coherent laser beam 104 into a beam of incoherent light 114.

In some embodiments, a partial reflection coating may be applied to the output port 112 to provide additional control of the output coupling efficiency. The output coupling efficiency is associated with a fraction of the circulating laser beam 104 that exits the optical cavity element 102 at each pass through the output port 112. By controlling the output coupling efficiency, the number of circulations and thus the distribution of optical path lengths may further be adjusted to achieve a desired balance between coherence reduction and overall transmission efficiency.

The laser source 106 may include any coherent light source suitable for generating a laser beam 104 having any temporal and/or spatial coherence. For example, the laser source 106 may include a mode-locked laser, a Q-switched laser, or any other pulsed or continuous-wave laser. The laser source 106 may operate at any suitable wavelength including, but not limited to, deep ultraviolet (DUV) wavelengths, ultraviolet wavelengths, visible wavelengths, or infrared wavelengths. In some embodiments, the laser source 106 may include a frequency-converted laser such as a harmonic generation laser.

It is further contemplated herein that an optical loss of the optical cavity element 102 may be based on various factors including, but not limited to, the composition of the optical cavity element 102, the absorption characteristics of the optical cavity element 102, optical path length of various portions of the laser beam 104 through the optical cavity element 102, or the surface roughness of polished surfaces 108 used for total internal reflection. Accordingly, the optical cavity element 102 may be formed from any optically-transparent material and in some cases may be selected based on the wavelength or spectrum of a known laser beam 104. In some embodiments, the optical cavity element 102 may utilize DUV grade calcium fluoride (CaF2) glass to achieve low loss for DUV wavelength applications. Similarly, the polished surfaces 108 of the optical cavity element 102 used as total internal reflection surfaces may be polished to any suitable surface smoothness to provide a desired optical loss. In some embodiments, the polished surfaces 108 are polished to achieve sub-nanometer surface roughness to bring surface scattering loss to part-per-million (PPM) levels or lower.

More generally, any aspect of the optical cavity element 102 may be designed to provide a desired level of temporal and/or spatial coherence reduction of an incident laser beam 104. For example, the geometry of the optical cavity element 102, the refractive index of the material, the size and placement of the input port 110 and the output port 112, the surface quality of the polished surfaces 108, and the input/output coupling efficiency may all be selected or adjusted to achieve a target coherence reduction. In some cases, the optical cavity element 102 may be designed in conjunction with characteristics of the laser beam 104 such as beam size, numerical aperture, or divergence to tailor the distribution of optical path lengths experienced by different portions of the laser beam 104. Additionally, the optical cavity element 102 may be designed to balance coherence reduction against other performance metrics such as transmission efficiency, output beam quality, or compatibility with downstream optical components.

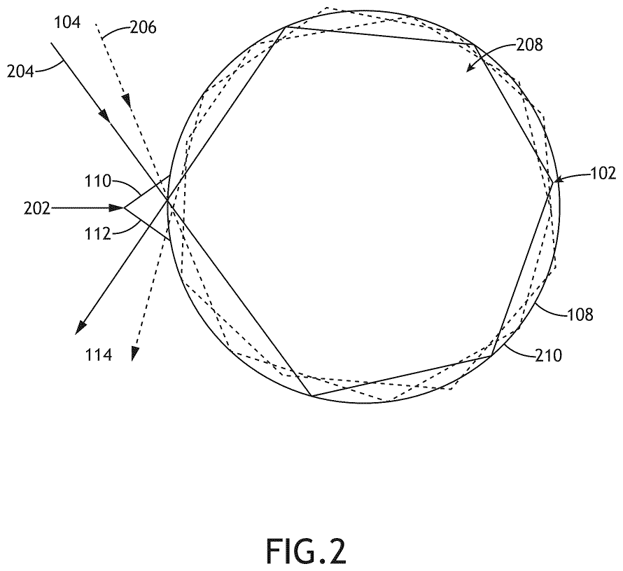

Referring now to FIGS. 2-5, various aspects of the design and performance of an optical cavity element 102 are described in greater detail, in accordance with one or more embodiments of the present disclosure.

The optical cavity element 102 may be implemented in various geometric configurations with different input/output coupling mechanisms. FIGS. 2-5 illustrate non-limiting examples of such configurations, including disk-shaped and ring-shaped optical cavity elements. These figures further illustrate various coupling mechanisms for the input port 110 and the output port 112, including prism-based coupling and notch-based coupling. It is to be understood, however, that FIGS. 2-5 and the associated descriptions are provided solely for illustrative purposes and should not be interpreted as limiting the scope of the present disclosure. The selection of a particular geometry and coupling mechanism may be based on design considerations such as desired optical path length distributions, coupling efficiency, manufacturability, or compatibility with downstream optical components.

FIG. 2 is a top view of an optical cavity element 102 configured as a disk with a circular cross-section, in accordance with one or more embodiments of the present disclosure.

In some embodiments, the optical cavity element 102 comprises a disk having a circular cross-section with two flat surfaces and a curved peripheral surface 210. For example, a flat surface 208 may be oriented perpendicular to a central axis of the disk, and the curved peripheral surface 210 may extend around the circumference of the disk between the two flat surfaces. In this configuration, the laser beam 104 may circulate within the optical cavity element 102 based on multiple total internal reflections from the curved peripheral surface 210.

FIG. 2 depicts a non-limiting illustration in which the input port 110 and the output port 112 are formed as different faces of a prism 202 located on the curved peripheral surface 210 of the disk. FIG. 2 further depicts how the optical path lengths of different portions of the laser beam 104 within the optical cavity element 102 may be controllable based on incidence angle or an incident location on the input port 110. For example, a first ray 204 entering at a first incidence angle may undergo a certain number of total internal reflections from the curved peripheral surface 210 before exiting through the output port 112, while a second ray 206 entering at a second incidence angle different from the first incidence angle may undergo a different number of total internal reflections different from the first number before exiting through the output port 112.

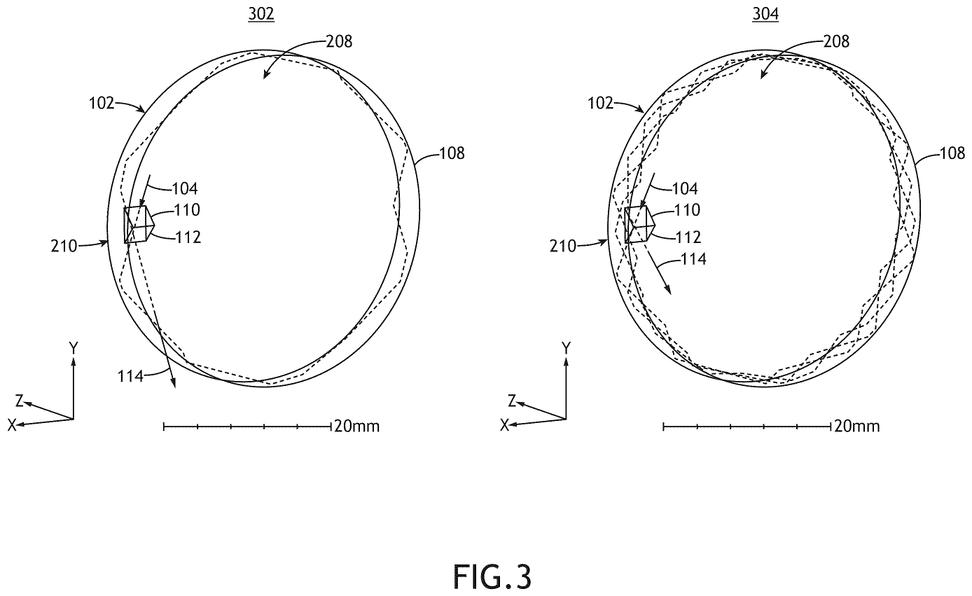

FIG. 3 illustrates a panel 302 and a panel 304 depicting perspective views of the optical cavity element 102 showing different optical path lengths within the optical cavity element 102 due to different incidence angles of the laser beam 104, in accordance with one or more embodiments of the present disclosure.

In FIG. 3, the input port 110 and the output port 112 are formed as different faces of a prism in contact with the flat surface 208 of the optical cavity element 102, rather than on the curved peripheral surface 210 as depicted in FIG. 2. Coupling the laser beam 104 into and out of the flat surface 208 may provide manufacturing advantages, as the flat surface 208 and a mating surface of the prism may be easier to fabricate and polish to achieve optical contact compared to curved surfaces. It is contemplated herein that optical contact may be advantageous for wavelengths below UV where optical adhesive cannot be used due to laser damage.

The panel 302 shows the laser beam 104 entering the optical cavity element 102 at a first incidence angle and undergoing a first number of total internal reflections from the polished surfaces 108 along a first optical path before exiting as the incoherent light 114 through the output port 112. The panel 304 shows the laser beam 104 entering the optical cavity element 102 at a second incidence angle different from the first incidence angle, causing the laser beam 104 to travel a longer optical path with more total internal reflections from the polished surfaces 108 before exiting as the incoherent light 114. The two panels again demonstrate that the optical path length of a particular portion of the laser beam 104 within the optical cavity element 102 may be controlled based on the incidence angle at the input port 110.

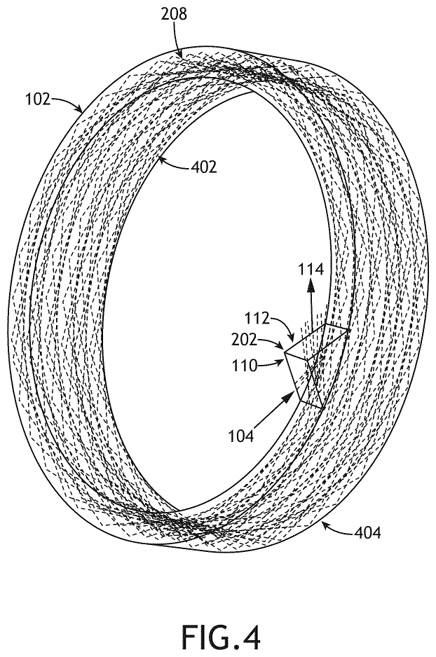

FIG. 4 is a perspective view of an optical cavity element 102 configured as a ring having an inner curved surface 402 and an outer curved surface 404, in accordance with one or more embodiments of the present disclosure.

In FIG. 4, the optical cavity element 102 may include an inner curved surface 402 defining an interior opening and an outer curved surface 404 defining the exterior boundary of the ring. The ring may also include two flat surfaces 208 extending between the inner curved surface 402 and the outer curved surface 404. In this configuration, the laser beam 104 may circulate within the ring based on multiple total internal reflections from the inner curved surface 402, and the outer curved surface 404, and/or any of the flat surface 208.

In FIG. 4, the input port 110 and the output port 112 is also formed as different faces of a prism 202 positioned on one of the flat surfaces of the ring in a manner similar to the configuration shown in FIG. 3 for the disk-shaped optical cavity element 102. However, this is a non-limiting illustration. In some embodiments, at least one of the input port 110 or the output port 112 may be located on at least one of the two flat surfaces, the inner curved surface 402, or the outer curved surface 404. The selection of port location may generally be based on design considerations such as coupling efficiency, manufacturability, or desired optical path length distributions.

In some embodiments, a width of the ring between the inner curved surface 402 and the outer curved surface 404 is selected to control a cross-sectional size of the incoherent light 114. For example, the width of the ring may constrain the spatial extent of the circulating laser beam 104 in the radial direction as the laser beam 104 bounces between the inner curved surface 402 and the outer curved surface 404 during circulation. By adjusting the ring width, the cross-sectional dimensions of the incoherent light 114 exiting through the output port 112 may be tailored to match downstream optical components or detector geometries. For example, the ring width may be selected to provide an output beam size that corresponds to a rectangular sensor shape used in a sample characterization system.

In some embodiments, the size of the input port 110 and/or the output port 112 may also be selected to control characteristics of the incoherent light 114. For example, the size of the output port 112 may influence the output coupling efficiency and the spatial extent of the extracted incoherent light 114. A larger output port 112 may allow more light to exit per circulation, which may increase overall transmission efficiency but may also reduce the average number of circulations and thus the spread of optical path lengths. Conversely, a smaller output port 112 may promote additional circulations and greater optical path length differences at the expense of transmission efficiency. Similarly, the size of the input port 110 may be selected to accommodate a desired beam size or numerical aperture of the laser beam 104, which in turn affects the distribution of incidence angles and the resulting spread of optical path lengths within the optical cavity element 102. In some cases, the input port 110 and the output port 112 may have different sizes to independently optimize injection efficiency and extraction characteristics. Further, these port size considerations may apply generally to any of the disclosed optical cavity element configurations, including disk-shaped, ring-shaped, or other geometries with prism-based or notch-based coupling.

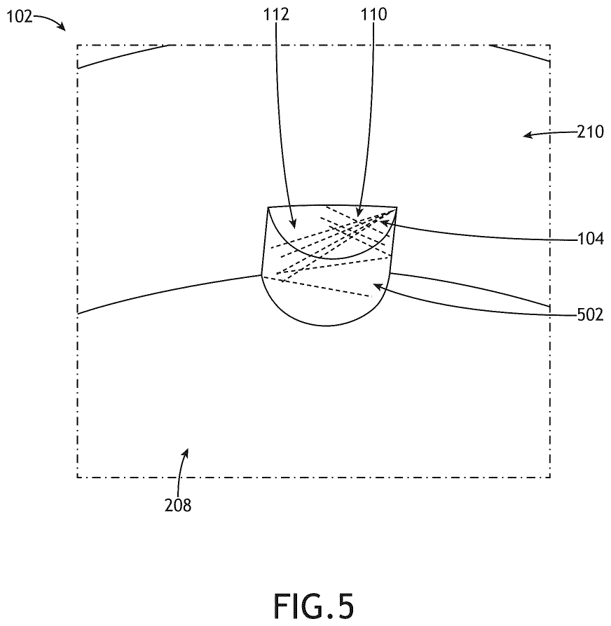

Referring now to FIG. 5, the input port 110 and/or the output port 112 may be formed using structures integrated directly into the optical cavity element 102. FIG. 5 is an interior perspective view of an optical cavity element 102 depicting a notch 502 formed in the curved peripheral surface 210 providing both the input port 110 and the output port 112, in accordance with one or more embodiments of the present disclosure.

In some embodiments, at least one of the input port 110 or the output port 112 is formed from a notch 502 in one of the polished surfaces of the optical cavity element 102. In this configuration, the laser beam 104 may enter the optical cavity element 102 through the input port 110 at the notch 502 and undergo multiple total internal reflections from the polished surfaces as the laser beam 104 circulates within the disk. Different portions of the laser beam 104 may travel different optical path lengths within the optical cavity element 102 based on incidence angles or incident locations at the notch 502.

The notch 502 may have various shapes suitable for input/output coupling. For example, the notch 502 may be round, triangular, trapezoidal, or any other shape. The shape of the notch 502 may be selected based on design considerations such as manufacturability, coupling efficiency, or desired beam characteristics. A triangular or trapezoidal notch 502 may provide different coupling characteristics compared to a round notch 502. In some embodiments, the notch 502 configuration may offer different manufacturing tradeoffs compared to a separate prism component, as the notch 502 may be machined directly into the optical cavity element 102 as a single monolithic part.

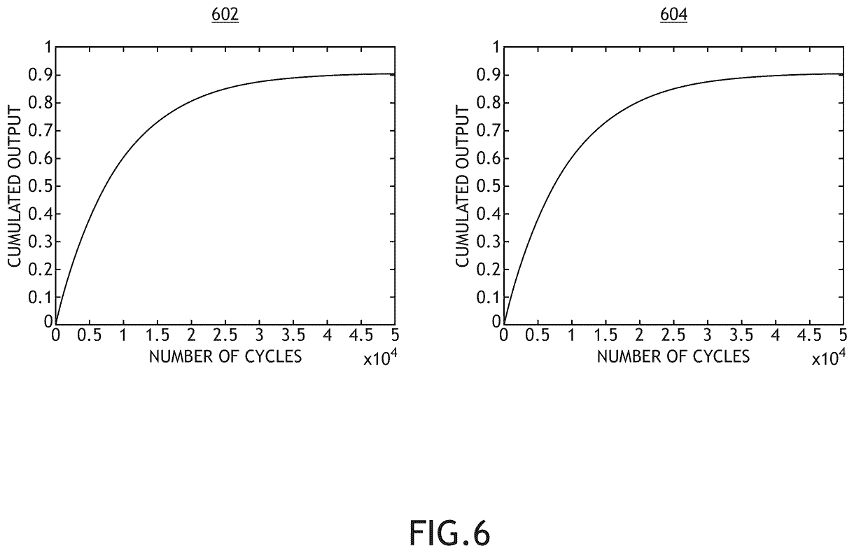

Referring now to FIG. 6, optical losses associated with the optical cavity element 102 are described in greater detail, in accordance with one or more embodiments of the present disclosure. These optical loss characteristics may be generally applicable to any design of the optical cavity element 102.

The efficiency of the optical cavity element 102 may be characterized by the output coupling and loss mechanisms that affect the laser beam 104 as the laser beam 104 circulates within the optical cavity element 102. Loss mechanisms may include, but are not limited to, scattering loss from the polished surfaces 108 used for total internal reflection, inherent absorption of the optically transparent material forming the optical cavity element 102, or scattering loss from the volume of the optically transparent material.

The total loss per cycle may be represented by a loss coefficient α, which accounts for all absorption and scattering losses experienced by the laser beam 104 during each circulation through the optical cavity element 102. The output coupling efficiency per cycle may be represented by a coupling coefficient T₀, which corresponds to the fraction of the circulating laser beam 104 that exits the optical cavity element 102 through the output port 112 at each pass.

Accordingly, the output efficiency of each cycle n may be expressed as:

T₁=(1−α)T₀ (1)

T₂=(1−α)²(1−T₀)T₀ (2)
. . . .

T₁=(1−α)ⁱ(1−T₀)ⁱ⁻¹T₀ (3)

And the total efficiency is given by:

$$( 4 )$$

$$T = {\sum }_{i = 1 , ∞} {T}_{i} = \frac{{T}_{0}}{1 - {T}_{0}} {\sum }_{i = 1 , ∞} {( 1 - α )}^{i} {( 1 - {T}_{0} )}^{i} = \frac{( 1 - α ) {T}_{0}}{α + {T}_{0} - α {T}_{0}}$$

Table 1 presents a range of total efficiency values based on different values of the loss coefficient α and the coupling coefficient T₀.

TABLE 1

| | T₀ | | | | | | | | | |
|---|---|---|---|---|---|---|---|---|---|---|
| α | 1.E−01 | 1.E−02 | 1.E−03 | 1.E−04 | 1.E−05 | 1.E−06 | 1.E−07 | 1.E−08 | 1.E−09 | 1.E−10 |
| 1.E−01 | 47% | 8% | 1% | 0% | 0% | 0% | 0% | 0% | 0% | 0% |
| 1.E−02 | 91% | 50% | 9% | 1% | 0% | 0% | 0% | 0% | 0% | 0% |
| 1.E−03 | 99% | 91% | 50% | 9% | 1% | 0% | 0% | 0% | 0% | 0% |
| 1.E−04 | 100% | 99% | 91% | 50% | 9% | 1% | 0% | 0% | 0% | 0% |
| 1.E−05 | 100% | 100% | 99% | 91% | 50% | 9% | 1% | 0% | 0% | 0% |
| 1.E−06 | 100% | 100% | 100% | 99% | 91% | 50% | 9% | 1% | 0% | 0% |
| 1.E−07 | 100% | 100% | 100% | 100% | 99% | 91% | 50% | 9% | 1% | 0% |
| 1.E−08 | 100% | 100% | 100% | 100% | 100% | 99% | 91% | 50% | 9% | 1% |
| 1.E−09 | 100% | 100% | 100% | 100% | 100% | 100% | 99% | 91% | 50% | 9% |
| 1.E−10 | 100% | 100% | 100% | 100% | 100% | 100% | 100% | 99% | 91% | 50% |

It is contemplated herein that various contributions to the loss may be controlled through material selection and/or manufacturing processes. For example, the surface scattering loss component of a may be reduced by using super-polished surfaces for the polished surfaces 108 to achieve sub-nanometer surface roughness. As another example, the internal absorption loss component of a may be minimized by using high-purity optical glasses such as DUV-grade calcium fluoride or fused silica. The combination of low surface scattering loss and low internal absorption loss may enable the optical cavity element 102 to support a large number of circulations while maintaining acceptable total transmission efficiency.

FIG. 6 illustrates a plot 602 and a plot 604 depicting cumulated output as a function of number of cycles through the optical cavity element 102, in accordance with one or more embodiments of the present disclosure.

The plot 602 displays cumulated output for a per-cycle loss of 1×10⁵/cm and output coupling efficiency of 0.01%. The plot 602 rises steeply from zero and approaches an asymptotic value near 0.9, indicating that approximately 91% of the input laser beam 104 may be extracted as the incoherent light 114 under these conditions. The plot 604 displays cumulated output efficiency for a higher loss per cycle of 1×10⁴/cm but lower output coupling efficiency of 0.001%, demonstrating that for higher loss per cycle, the output coupling needs to be reduced to maintain the same number of averages (therefore the same speckle contrast) and the same output efficiency.

The comparison between the plot 602 and the plot 604 illustrates a trade-off between transmission efficiency and speckle reduction. Lower output coupling efficiency (smaller T₀) may promote additional circulations of the laser beam 104 within the optical cavity element 102, which may increase the spread of optical path lengths and provide greater coherence reduction. However, when the laser beam 104 circulates for a larger number of cycles, the cumulative effect of absorption and scattering losses may reduce the total transmission efficiency. Conversely, higher output coupling efficiency may increase transmission efficiency but may reduce the average number of circulations and thus the spread of optical path lengths available for coherence reduction.

The optical cavity element 102 may be designed to achieve any desired total efficiency by balancing absorption loss and output coupling efficiency, where the selection may depend on depending on the specific combination of material properties, surface quality, and output coupling parameters. For applications where coherence reduction is prioritized over transmission efficiency, the optical cavity element 102 may be designed with lower output coupling efficiency to promote a greater number of circulations. For applications where higher transmission efficiency is desired, the optical cavity element 102 may be designed with higher output coupling efficiency and lower-loss materials.

The selection of a target efficiency within this range may depend on application requirements such as the desired level of speckle contrast reduction, the available laser power from the laser source 106, and the power requirements of downstream optical components or sample characterization systems. For example, an application requiring high speckle reduction may tolerate lower transmission efficiency to achieve a greater number of circulations and larger optical path length differences, while an application with limited laser power may prioritize higher transmission efficiency at the expense of some coherence reduction capability.

Referring now generally to FIG. 1, the incoherent light source 100 may include one or more optical components positioned prior to the input port 110 to control characteristics of the laser beam 104 before injection into the optical cavity element 102. As described above, the optical path length of a particular portion of the laser beam 104 within the optical cavity element 102 may be controlled based on at least one of an incidence angle or an incident location on the input port 110. Accordingly, controlling the angular spread and/or spatial extent of the laser beam 104 prior to injection may provide additional control over the distribution of optical path lengths within the optical cavity element 102 and the resulting coherence reduction of the incoherent light 114.

In some embodiments, the incoherent light source 100 includes a diffuser prior to the input port 110 to control an angular spread of the laser beam 104 entering the input port 110. The diffuser may be positioned in the optical path between the laser source 106 and the input port 110 of the optical cavity element 102. The diffuser may scatter the laser beam 104 to increase the range of incidence angles at which different portions of the laser beam 104 enter the optical cavity element 102 through the input port 110. By controlling the angular spread of the laser beam 104, the diffuser may influence the number of circulations that different portions of the laser beam 104 undergo within the optical cavity element 102, which in turn affects the spread of optical path lengths and the degree of coherence reduction achieved.

In some embodiments, a diffractive optical element and a random phase plate diffuser may be used together to expand a beam divergence angle and a beam size of the laser beam 104 simultaneously before injection into the optical cavity element 102. The diffractive optical element may modify the wavefront of the laser beam 104 to produce a desired angular distribution, while the random phase plate diffuser may introduce random phase variations across the beam cross-section to further increase the angular spread. The combination of these two elements may provide independent control over both the divergence angle and the spatial extent of the laser beam 104 at the input port 110, allowing the distribution of optical path lengths within the optical cavity element 102 to be tailored for a particular application.

In some embodiments, a separate diffuser may be placed in front of a coupling prism forming the input port 110 to improve illumination uniformity. The separate diffuser may scatter the laser beam 104 prior to injection, which may result in a more uniform distribution of incidence angles and incident locations at the input port 110. The more uniform input distribution may translate to a more uniform spatial and angular distribution of the incoherent light 114 exiting the output port 112.

In some embodiments, a rotating diffuser may be combined with the optical cavity element 102 to further reduce speckle contrast through multiplicative speckle reduction. The rotating diffuser may be positioned prior to the input port 110 or after the output port 112 of the optical cavity element 102. When the rotating diffuser is used in combination with the optical cavity element 102, the speckle reduction achieved by each mechanism may multiply together rather than add, providing greater overall speckle contrast reduction than either mechanism alone. For example, if the optical cavity element 102 provides a first level of speckle reduction through static optical path length differences, and the rotating diffuser provides a second level of speckle reduction through temporal averaging, the combined speckle reduction may be the product of the two individual reductions. This multiplicative effect may allow the optical cavity element 102 to be designed with fewer circulations while still achieving a target speckle contrast level when combined with a rotating diffuser.

In some embodiments, an acousto-optic deflector (AOD) or a resonant mirror scanner may be used to dither the laser beam 104 prior to injection into the optical cavity element 102 to further reduce speckle contrast. The AOD or resonant mirror scanner may rapidly vary the angle or position of the laser beam 104 at the input port 110, causing different portions of the laser beam 104 to enter the optical cavity element 102 at time-varying incidence angles or incident locations. The time-varying input conditions may result in time-varying speckle patterns in the incoherent light 114, which may be averaged over an integration time of a downstream detector to provide additional speckle contrast reduction. The AOD or resonant mirror scanner may operate at frequencies sufficient to provide multiple speckle pattern variations within the integration time of the detector.

In some embodiments, a diffractive optical element (DOE) may be used to generate multiple beams from the laser beam 104 to improve illumination uniformity. The DOE may split the laser beam 104 into a plurality of beams that enter the optical cavity element 102 through the input port 110 at different angles or locations. The multiple beams may circulate within the optical cavity element 102 along different optical paths, and the resulting incoherent light 114 may exhibit improved spatial uniformity compared to a single input beam. The DOE may be designed to produce a specific pattern of beams tailored to the geometry of the optical cavity element 102 and the desired characteristics of the incoherent light 114.

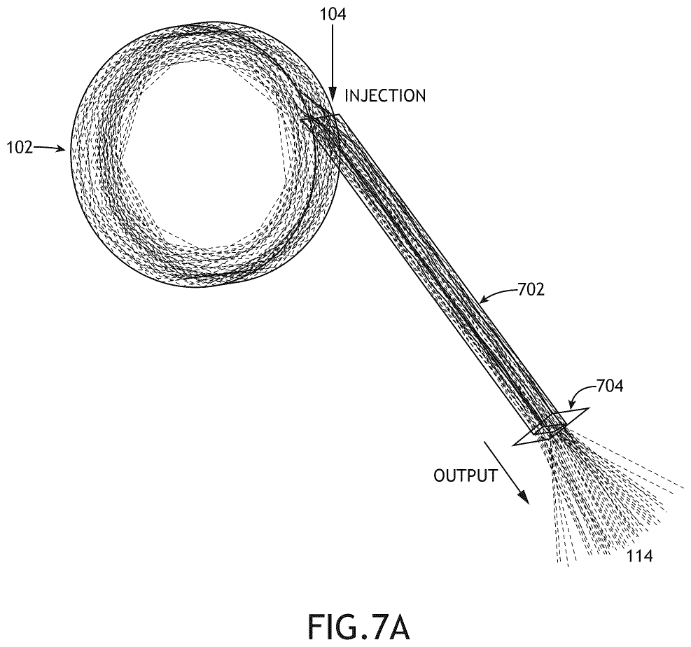

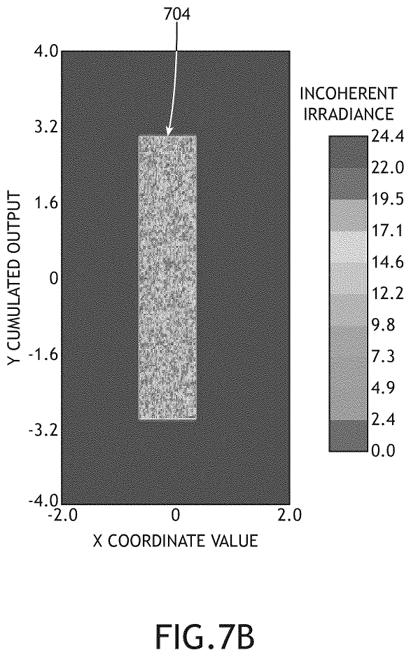

Referring now to FIGS. 7A-7B, the incoherent light source 100 may include one or more elements to manipulate a spatial homogeneity of the incoherent light 114 provided by the optical cavity element 102. While the optical cavity element 102 provides temporal and/or spatial coherence reduction by imparting different optical path lengths on different portions of the laser beam 104, the spatial intensity distribution of the incoherent light 114 exiting the output port 112 may not necessarily be uniform. However, some applications, such as sample characterization systems requiring consistent illumination across a field of view, spatial homogeneity of the illumination may be beneficial. Accordingly, additional optical components may be incorporated with the optical cavity element 102 to improve the spatial uniformity of the incoherent light 114 while preserving the coherence reduction achieved by the optical cavity element 102.

FIG. 7A is a perspective view of an optical cavity element 102 with an integrated light pipe 702 for generating spatially-uniform incoherent illumination, in accordance with one or more embodiments of the present disclosure.

In some embodiments, the incoherent light source 100 includes a light pipe 702 optically coupled to or forming the output port 112 of the optical cavity element 102, where the light pipe 702 is configured to increase spatial homogeneity of the incoherent light 114. The light pipe 702 may be coupled to the optical cavity element 102 in various configurations. For example, the light pipe 702 may be a separate component in optical contact with the optical cavity element 102, or the light pipe 702 may be monolithically integrated with the optical cavity element 102. The light pipe 702 may be coupled to the optical cavity element 102 at any suitable location, including on a flat surface 208 or a curved peripheral surface 210 of the optical cavity element 102.

In the non-limiting example depicted in FIG. 7A, one end of the light pipe 702 has a slanted end surface. In this configuration, a portion of one side surface of the light pipe 702 is in optical contact with the optical cavity element 102 and an angle of the end surface of the light pipe 702 is configured for injecting the laser beam 104 into the optical cavity element 102. In this configuration, the slanted end surface of the light pipe 702 serves as the input port 110 and the portion of the side surface in contact with the optical cavity element serves as output port 112 for coupling light into and out of the optical cavity element 102.

The light pipe 702 increases spatial homogeneity of the incoherent light 114 by mixing and redistributing the light as the incoherent light 114 propagates through the light pipe 702. The incoherent light 114 exiting the output port 112 may have non-uniform spatial intensity distribution due to the different optical paths traveled by different portions of the laser beam 104 within the optical cavity element 102. As the incoherent light 114 propagates through the light pipe 702, multiple reflections from the interior surfaces of the light pipe 702 may redistribute the light spatially, resulting in a more uniform intensity distribution at an output face 704 of the light pipe 702. In FIG. 7A, the spatially-homogenized incoherent light 114 exits the light pipe 702 from an output face 704.

The output face 704 of the light pipe 702 may have any size or shape such as, but not limited to, square, rectangular, circular, or polygonal shapes. In some embodiments, the light pipe 702 has a rectangular cross-section configured to match a shape of a sensor. For example, the cross-sectional shape of the light pipe 702 may be selected to correspond to a rectangular detector used in a sample characterization system, such as a time delay integration (TDI) sensor. By matching the cross-sectional shape of the light pipe 702 to the sensor shape, the incoherent light 114 exiting the output face 704 may be efficiently coupled to the sensor with reduced light loss.

FIG. 7B is a plot of irradiance of incoherent light 114 at the output face 704 of the light pipe 702, in accordance with one or more embodiments of the present disclosure. The relatively uniform irradiance distribution shown in FIG. 7B indicates that the light pipe 702 may effectively homogenize the spatial intensity distribution of the incoherent light 114 extracted from the optical cavity element 102.

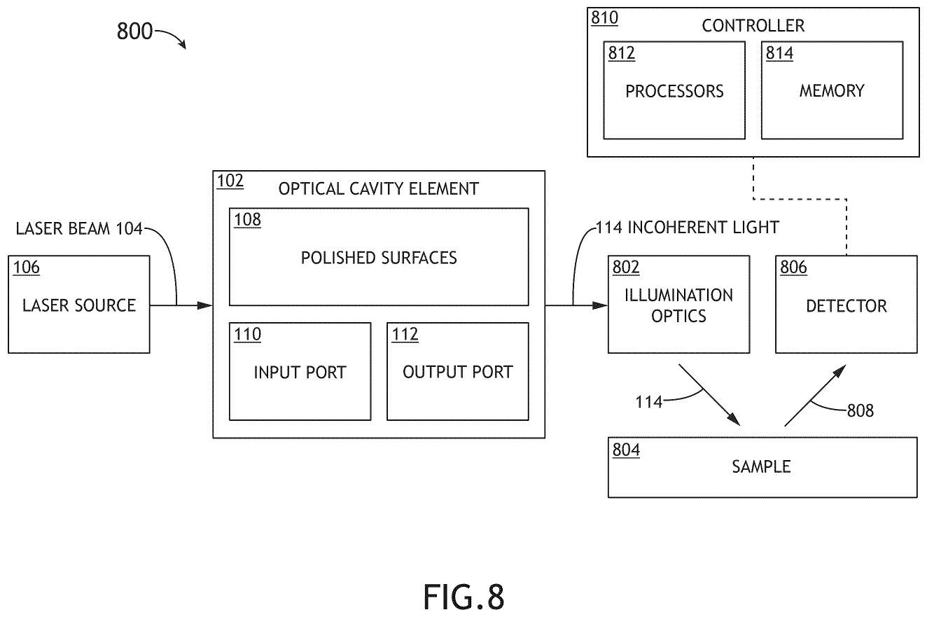

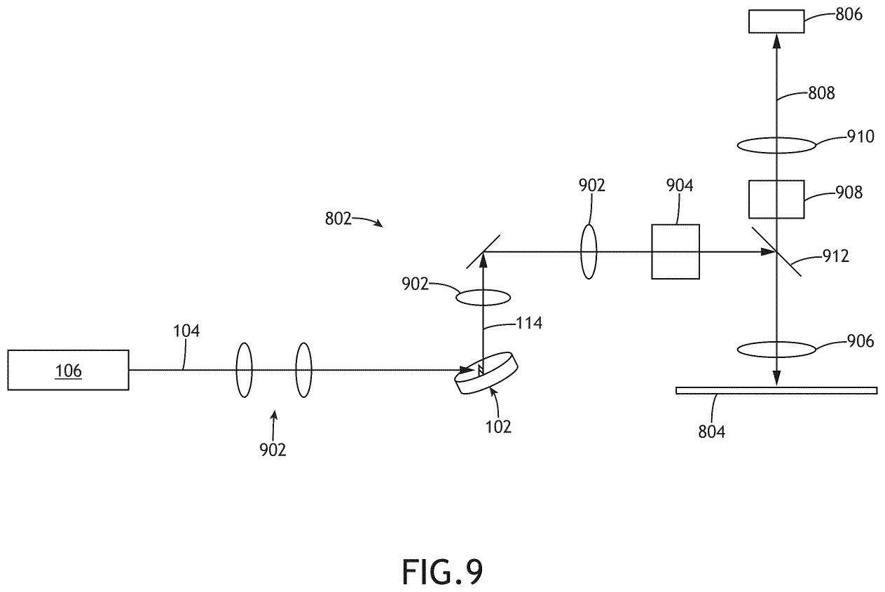

Referring now to FIGS. 8-9, the optical cavity element 102, or an incoherent light source 100 more generally, may be integrated into additional systems.

FIG. 8 is a block diagram of a sample characterization system 800 incorporating the optical cavity element 102 for generating incoherent illumination from a coherent laser source, in accordance with one or more embodiments of the present disclosure.

In embodiments, the sample characterization system 800 includes a laser source 106 configured to generate a laser beam 104, which may be directed into the optical cavity element 102 to generate incoherent light 114. In this way, the sample characterization system 800 may incorporate the incoherent light source 100.

The sample characterization system 800 may include illumination optics 802 configured to direct the incoherent light 114 to a sample 804. The illumination optics 802 may include any combination of optical elements suitable for conditioning and directing the incoherent light 114 to the sample 804. For example, the illumination optics 802 may include lenses, mirrors, polarizers, filters, apertures, or other optical components arranged to shape, focus, or otherwise modify the incoherent light 114 before the incoherent light 114 reaches the sample 804. In some embodiments, the incoherent light 114 may be relayed either onto a pupil of an objective lens or directly onto the sample 804 depending on a layout of an imaging system within the sample characterization system 800.

The sample characterization system 800 may deliver the incoherent light 114 to the sample 804 using any suitable technique. In some embodiments, the sample characterization system 800 delivers the incoherent light 114 to the sample 804 using free-space optical components. In some embodiments, an optical fiber may be combined with the output port 112 for remote delivery of the incoherent light 114. The optical fiber may receive the incoherent light 114 from the output port 112 and transmit the incoherent light 114 to a remote location where the illumination optics 802 and the sample 804 are positioned. Because the incoherent light 114 has reduced coherence compared to the laser beam 104, the power level of the incoherent light 114 transmitted through the optical fiber may be lower than the power level of the original laser beam 104, which may reduce the risk of fiber damage during transmission.

The sample characterization system 800 may include a detector 806 configured to detect sample light 808 from the sample 804. The sample light 808 may include light reflected, scattered, diffracted, or otherwise emanating from the sample 804 in response to illumination by the incoherent light 114. The detector 806 may include any detector suitable for capturing the sample light 808, such as, but not limited to, a charge-coupled device (CCD), a complementary metal-oxide-semiconductor (CMOS) sensor, a time delay integration (TDI) sensor, a photodiode array, or any other imaging or non-imaging detector.

The sample characterization system 800 may include a controller 810 having one or more processors 812 and memory 814. The controller 810 may be communicatively coupled to the detector 806 and configured to receive signals from the detector 806. The one or more processors 812 may be configured to execute program instructions stored in the memory 814 causing the one or more processors 812 to generate one or more measurements of the sample 804 based on signals from the detector 806.

The one or more processors 812 of the controller 810 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 812 may include any device configured to execute algorithms and/or instructions (e.g., program instructions stored in the memory 814). In some embodiments, the one or more processors 812 may be embodied as a desktop computer, mainframe computer system, workstation, image computer, parallel processor, networked computer, or any other computer system configured to execute a program configured to operate or operate in conjunction with the sample characterization system 800, as described throughout the present disclosure.

The memory 814 may include any storage medium known in the art suitable for storing program instructions executable by the associated one or more processors 812. For example, the memory 814 may include a non-transitory memory medium. By way of another example, the memory 814 may include, but is not limited to, a read-only memory (ROM), a random-access memory (RAM), a magnetic or optical memory device (e.g., disk), a magnetic tape, a solid-state drive and the like. It is further noted that the memory 814 may be housed in a common controller housing with the one or more processors 812. In some embodiments, the memory 814 may be located remotely with respect to the physical location of the one or more processors 812 and the controller 810. For instance, the one or more processors 812 of the controller 810 may access a remote memory (e.g., server), accessible through a network (e.g., internet, intranet and the like).

The sample characterization system 800 may provide any type of measurements or characterizations of a sample 804 based on the incoherent light 114.

In some embodiments, the sample characterization system 800 includes an inspection tool, where the one or more measurements comprise at least one of identifying or categorizing defects on the sample 804. For example, the sample characterization system 800 may be configured as a wafer inspection tool for detecting and classifying defects on semiconductor wafers. In this configuration, the incoherent illumination provided by the optical cavity element 102 may reduce speckle noise in images captured by the detector 806, which may improve defect detection sensitivity compared to coherent illumination. The one or more processors 812 may then execute program instructions to analyze the sample light 808 captured by the detector 806 and identify locations, sizes, types, or other characteristics of defects on the sample 804.

In some embodiments, the sample characterization system 800 includes a metrology tool, where the one or more measurements comprise one or more measurements of a physical property of the sample 804. For example, the sample characterization system 800 may be configured to measure dimensions, overlay, film thickness, surface topography, or other physical properties of features on the sample 804. The incoherent illumination provided by the optical cavity element 102 may reduce coherent artifacts in metrology measurements, which may improve measurement accuracy and repeatability.

FIG. 9 is a schematic diagram of a sample characterization system 800 providing brightfield characterization of a sample 804, in accordance with one or more embodiments of the present disclosure.

FIG. 9 depicts a non-limiting implementation of the sample characterization system 800 in which the incoherent light 114 generated by the optical cavity element 102 is used for brightfield illumination of the sample 804. In this configuration, the sample characterization system 800 includes a laser source 106 configured to generate a laser beam 104, which is directed into the optical cavity element 102 to produce the incoherent light 114 with reduced temporal and/or spatial coherence compared to the laser beam 104.

In embodiments, the illumination optics 802 of the sample characterization system 800 include a plurality of illumination lenses 902 arranged along an optical path between the optical cavity element 102 and the sample 804. The illumination lenses 902 may be configured to condition, shape, focus, or otherwise modify the incoherent light 114 as the incoherent light 114 propagates toward the sample 804. For example, the illumination lenses 902 may relay the incoherent light 114 from the output port 112 of the optical cavity element 102 to the sample 804, or the illumination lenses 902 may relay the incoherent light 114 onto a pupil of an objective lens 906 depending on the illumination configuration. The illumination optics 802 may further include optical elements to condition the incoherent light 114 such as, but not limited to, spectral filters, spatial filters, or homogenizers.

In some embodiments, the illumination optics 802 include an illumination polarizer 904 positioned in the optical path of the incoherent light 114 between the optical cavity element 102 and the sample 804. The illumination polarizer 904 may be configured to control a polarization state of the incoherent light 114 incident on the sample 804.

In some embodiments, the sample characterization system 800 includes an objective lens 906 configured to focus the incoherent light 114 onto the sample 804. The objective lens 906 may have a high numerical aperture (NA) to provide high-resolution imaging of the sample 804. The objective lens 906 may also collect sample light 808 from the sample 804 in response to illumination by the incoherent light 114. In a brightfield configuration, the sample light 808 may include specularly reflected light reflected from the sample 804.

In some embodiments, the sample characterization system 800 includes a beamsplitter 912 positioned in the optical path to separate illumination and collection optical paths. The beamsplitter 912 may direct the incoherent light 114 toward the objective lens 906 and the sample 804 while allowing the sample light 808 collected by the objective lens 906 to pass toward the detector 806. The beamsplitter 912 may include any suitable beam-splitting element such as, but not limited to, a plate beamsplitter, a cube beamsplitter, or a pellicle beamsplitter.

In some embodiments, the sample characterization system 800 includes a collection polarizer 908 positioned in a collection optical path between the objective lens 906 and the detector 806. The collection polarizer 908 may be configured to select a polarization state of the sample light 808 before the sample light 808 reaches the detector 806. The collection polarizer 908 may be used in combination with the illumination polarizer 904 to provide polarization-based contrast or to suppress unwanted reflections from the sample 804.

In some embodiments, the sample characterization system 800 includes one or more imaging optics to image the sample 804 onto the detector 806 based on illumination by the incoherent light 114. The one or more imaging optics may include the objective lens 906 and a tube lens 910 (e.g., a magnification tube lens 910), which together may form an imaging system that produces an image of the sample 804 on the detector 806. The one or more imaging optics may further include optical elements to condition the incoherent light 114 and/or the sample light 808 such as, but not limited to, spectral filters, spatial filters, or homogenizers. The incoherent illumination provided by the optical cavity element 102 may reduce speckle noise and coherent artifacts in the image captured by the detector 806, which may improve image quality for brightfield inspection or metrology applications.

For example, FIG. 9 depicts the objective lens 906 and a magnification tube lens 910 positioned in the collection optical path between the beamsplitter 912 and the detector 806. In this configuration, the magnification tube lens 910 may be configured to focus or relay the sample light 808 onto the detector 806 with a desired magnification.

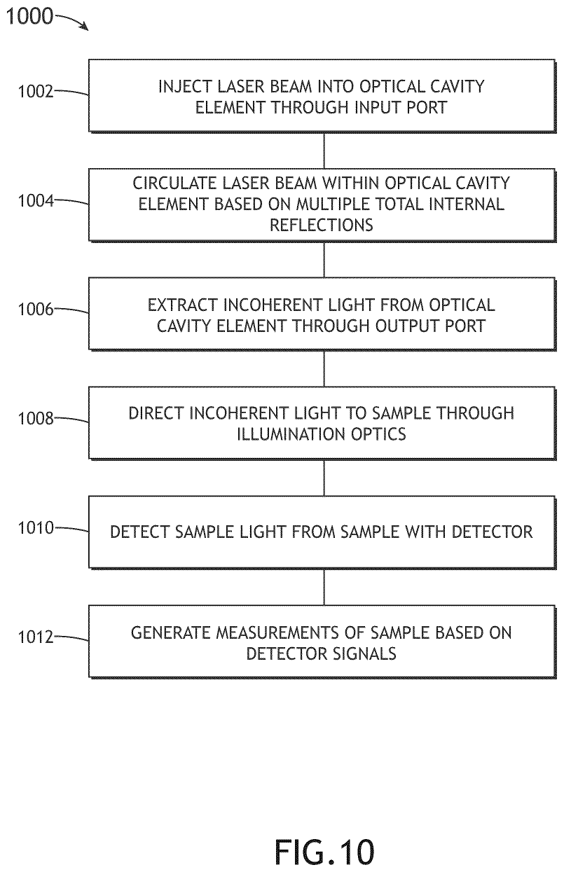

Referring now to FIG. 10, a flowchart illustrating a method 1000 is depicted, in accordance with one or more embodiments of the present disclosure. The embodiments and enabling technologies described previously herein in the context of the sample characterization system 800 should be interpreted to extend to the method 1000. For example, the processors 812 of the controller 810 may be configured to execute program instructions stored on the memory 814, where the program instructions cause the processors 812 to perform any of the steps of the method 1000 either directly or indirectly (e.g., by generating control signals to direct another component to perform an action). However, the method 1000 is not limited to the architecture of the optical cavity element 102, the incoherent light source 100, or the sample characterization system 800.

FIG. 10 is a flowchart illustrating the method 1000 for generating incoherent illumination from a coherent laser source, in accordance with one or more embodiments of the present disclosure.

In some embodiments, the method 1000 includes a step 1002 of injecting a laser beam into an optical cavity element through an input port, wherein the optical cavity element is formed from an optically transparent material having polished surfaces. This step may involve directing the laser beam 104 from the laser source 106 toward the input port 110 of the optical cavity element 102. The laser beam 104 may enter the optical cavity element 102 through the input port 110 at one or more incidence angles and/or at one or more incident locations on the input port 110. For example, the laser beam 104 may be focused or shaped by upstream optical components to provide a desired range of incidence angles at the input port 110. In some cases, a diffuser may be positioned prior to the input port 110 to control an angular spread of the laser beam 104 entering the optical cavity element 102. The optical cavity element 102 may be formed from an optically transparent material such as, but not limited to, fused silica or calcium fluoride, with the polished surfaces 108 configured to support total internal reflection.

In some embodiments, the method 1000 includes a step 1004 of circulating the laser beam within the optical cavity element based on multiple total internal reflections from at least some of the polished surfaces, wherein different portions of the laser beam travel different optical path lengths within the optical cavity element. This step may involve the laser beam 104 undergoing multiple total internal reflections from the polished surfaces 108 of the optical cavity element 102 as the laser beam 104 propagates within the optical cavity element 102. Different portions of the laser beam 104 may travel different optical path lengths within the optical cavity element 102 based on at least one of an incidence angle or an incident location on the input port 110. For example, a portion of the laser beam 104 entering at a first incidence angle may undergo a first number of total internal reflections before reaching the output port 112, while another portion of the laser beam 104 entering at a second incidence angle different from the first incidence angle may undergo a second number of total internal reflections different from the first number before reaching the output port 112. The optical path length of a particular portion of the laser beam 104 within the optical cavity element 102 may thus be based on at least one of an incidence angle or an incident location on the input port 110.

In some embodiments, the method 1000 includes a step 1006 of extracting incoherent light from the optical cavity element through an output port, wherein at least one of a temporal coherence or a spatial coherence is smaller for the incoherent light than for the laser beam. This step may involve the incoherent light 114 exiting the optical cavity element 102 through the output port 112 after different portions of the laser beam 104 have traveled different optical path lengths within the optical cavity element 102. Because the optical path length differences between different portions of the laser beam 104 may exceed the coherence length of the laser beam 104, the portions of the laser beam 104 that exit through the output port 112 may recombine incoherently to provide the incoherent light 114 with reduced temporal and/or spatial coherence compared to the laser beam 104. In some cases, at least one of the input port 110 or the output port 112 is formed from a prism in contact with at least one of the polished surfaces 108 of the optical cavity element 102. For example, the prism 202 may be in optical contact with the flat surface 208 or the curved peripheral surface 210 of the optical cavity element 102, with different faces of the prism 202 serving as the input port 110 and the output port 112.

In some embodiments, the method 1000 includes a step 1008 of directing the incoherent light to a sample through illumination optics. This step may involve the illumination optics 802 receiving the incoherent light 114 from the output port 112 of the optical cavity element 102 and directing the incoherent light 114 to the sample 804. The illumination optics 802 may include any combination of optical elements such as, but not limited to, the illumination lenses 902, the illumination polarizer 904, the objective lens 906, or the beamsplitter 912. For example, the illumination lenses 902 may relay the incoherent light 114 from the output port 112 to the sample 804, or the illumination lenses 902 may relay the incoherent light 114 onto a pupil of the objective lens 906 depending on the illumination configuration of the sample characterization system 800.

In some embodiments, the method 1000 includes a step 1010 of detecting sample light from the sample with a detector. This step may involve the detector 806 capturing the sample light 808 emanating from the sample 804 in response to illumination by the incoherent light 114. The sample light 808 may include light reflected, scattered, diffracted, or otherwise emanating from the sample 804. In a brightfield configuration, the sample light 808 may include specularly reflected light collected by the objective lens 906 and directed through the collection polarizer 908 and the tube lens 910 to the detector 806.

In some embodiments, the method 1000 includes a step 1012 of generating one or more measurements of the sample based on signals from the detector. This step may involve the controller 810 receiving signals from the detector 806 and the processors 812 executing program instructions stored in the memory 814 to generate one or more measurements of the sample 804 based on the signals. The one or more measurements may include at least one of identifying or categorizing defects on the sample 804 when the sample characterization system 800 is configured as an inspection tool. The one or more measurements may include one or more measurements of a physical property of the sample 804 when the sample characterization system 800 is configured as a metrology tool.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random-access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An optical system, comprising:
an optical cavity element formed from an optically transparent material having polished surfaces, wherein the optical cavity element includes an input port configured to inject a laser beam into the optical cavity element and an output port configured to extract incoherent light from the optical cavity element, wherein the laser beam circulates within the optical cavity element based on multiple total internal reflections from at least some of the polished surfaces, wherein different portions of the laser beam travel different optical path lengths within the optical cavity element, wherein at least one of a temporal coherence or a spatial coherence is smaller for the incoherent light than for the laser beam.

2. The optical system of claim 1, wherein an optical path length of a particular portion of the laser beam within the optical cavity element is controllable based on at least one of an incidence angle or an incident location on the input port.

3. The optical system of claim 2, wherein at least one of a size or a shape of the optical cavity element is configured to provide that a spread of the different optical path lengths is greater than a selected coherence length.

4. The optical system of claim 1, wherein at least one of the input port or the output port is formed from a prism in contact with at least one of the polished surfaces.

5. The optical system of claim 1, wherein at least one of the input port or the output port is formed from a notch in one of the polished surfaces.

6. The optical system of claim 1, wherein the optical cavity element comprises a disk having a circular cross-section with two flat surfaces and a curved peripheral surface.

7. The optical system of claim 1, wherein the optical cavity element comprises a ring having two flat surfaces, an inner curved surface, and an outer curved surface.

8. The optical system of claim 7, wherein a width of the ring between the inner curved surface and the outer curved surface is configured to control a cross-sectional size of the incoherent light.

9. The optical system of claim 7, wherein at least one of the input port or the output port is located on at least one of the two flat surfaces, the inner curved surface, or the outer curved surface.

10. The optical system of claim 1, further comprising a light pipe optically coupled to the output port, wherein the light pipe is configured to increase spatial homogeneity of the incoherent light.

11. The optical system of claim 10, wherein the light pipe has a rectangular cross-section configured to match a shape of a sensor.

12. The optical system of claim 1, further comprising a diffuser prior to the input port to control an angular spread of the laser beam entering the input port.

13. The optical system of claim 1, wherein the optically transparent material comprises at least one of fused silica or calcium fluoride.

14. A sample characterization tool comprising:
a laser source configured to generate a laser beam;
an optical cavity element formed from an optically transparent material having polished surfaces, wherein the optical cavity element includes an input port configured to receive the laser beam and an output port configured to extract incoherent light from the optical cavity element, wherein the laser beam circulates within the optical cavity element based on multiple total internal reflections from at least some of the polished surfaces, wherein different portions of the laser beam travel different optical path lengths within the optical cavity element, wherein at least one of a temporal coherence or a spatial coherence is smaller for the incoherent light than for the laser beam;
illumination optics configured to direct the incoherent light to a sample;
a detector configured to detect light from the sample; and
a controller including one or more processors configured to execute program instructions causing the one or more processors to generate one or more measurements of the sample based on signals from the detector.

15. The sample characterization tool of claim 14, wherein the sample characterization tool comprises an inspection tool, wherein the one or more measurements comprise at least one of identifying or categorizing defects on the sample.

16. The sample characterization tool of claim 14, wherein the sample characterization tool comprises a metrology tool, wherein the one or more measurements comprise one or more measurements of a physical property of the sample.

17. The sample characterization tool of claim 14, further comprising one or more imaging optics to image the sample onto the detector based on illumination by the incoherent light.

18. The sample characterization tool of claim 14, wherein the laser source comprises at least one of a mode-locked laser or a Q-switched laser.

19. The sample characterization tool of claim 14, wherein an optical path length of a particular portion of the laser beam within the optical cavity element is controllable based on at least one of an incidence angle or an incident location on the input port.

20. The sample characterization tool of claim 14, wherein at least one of a size or a shape of the optical cavity element is configured to provide that a spread of the different optical path lengths is greater than a coherence length of the laser beam.

21. The sample characterization tool of claim 14, wherein at least one of the input port or the output port is formed from a prism in contact with at least one of the polished surfaces.

22. The sample characterization tool of claim 14, wherein the optical cavity element comprises a disk having a circular cross-section with two flat surfaces and a curved peripheral surface.

23. The sample characterization tool of claim 14, wherein the optical cavity element comprises a ring having an inner curved surface and an outer curved surface.

24. A method for generating incoherent illumination from a coherent laser source, comprising:
injecting a laser beam into an optical cavity element through an input port, wherein the optical cavity element is formed from an optically transparent material having polished surfaces;
circulating the laser beam within the optical cavity element based on multiple total internal reflections from at least some of the polished surfaces, wherein different portions of the laser beam travel different optical path lengths within the optical cavity element; and
extracting incoherent light from the optical cavity element through an output port, wherein at least one of a temporal coherence or a spatial coherence is smaller for the incoherent light than for the laser beam.

25. The method of claim 24, wherein an optical path length of a particular portion of the laser beam within the optical cavity element is based on at least one of an incidence angle or an incident location on the input port.

26. The method of claim 24, wherein at least one of the input port or the output port is formed from a prism in contact with at least one of the polished surfaces of the optical cavity element.
